(19) United States
(12) Patent Application Publication
(10) Pub. No.: US 2021/0382577 A1
(43) Pub. Date: Dec. 9, 2021

(54) ELECTROSTATIC SENSOR, CONTROL DEVICE, AND NON-TRANSITORY COMPUTER-READABLE MEDIUM

(71) Applicant: KABUSHIKI KAISHA TOKAI RIKA DENKI SEISAKUSHO, Aichi (JP)

(72) Inventors: Takao IMAI, Aichi (JP); Katsuhiro TSUCHIYA, Aichi (JP)

(73) Assignee: KABUSHIKI KAISHA TOKAI RIKA DENKI SEISAKUSHO, Aichi (JP)

(21) Appl. No.: 17/330,894

(22) Filed: May 26, 2021

(30) Foreign Application Priority Data
Jun. 5, 2020 (JP) 2020-098572

(51) Int. Cl. G06F 3/044; G06F 3/0488; B60K 35/00

(52) U.S. Cl. CPC G06F 3/0443; B60K 35/00; G06F 3/0488

(57) ABSTRACT

A detection device is configured to detect an electrostatic capacitance between an operated member having a plurality of detection areas and an electrode having areas associated with the detection areas respectively. A control device is configured to determine whether an operation is performed to each of the detection areas based on whether the electrostatic capacitance exceeds a first threshold value. In a case where the electrostatic capacitance exceeds the first threshold value for one of the detection areas, the control device determines whether an operation is performed to another detection area based on a second threshold value that is higher than the first threshold value.

### FIELD

The presently disclosed subject matter relates to an electrostatic sensor equipped with an operated member (a member to be operated) having a plurality of detection areas. The presently disclosed subject matter also relates to a control device configured to control an operation of the electrostatic sensor, as well as a non-transitory computer-readable medium having stored a computer program adapted to be executed by a processor of the control device.

### BACKGROUND

Japanese Patent Publication No. 2015-210811A discloses an electrostatic sensor. In the electrostatic sensor, a pseudo capacitor is formed by an approach of a finger or the like of a user to an operated member located in an electric field generated by an electrode, so that an electrostatic capacitance between the electrode and the operated member is increased. When the increase in the electrostatic capacitance is detected, it is determined whether an operation with respect to the operated member is performed by the user.

### SUMMARY

### Technical Problem

It is demanded to improve the operability of an electrostatic sensor equipped with an operated member having a plurality of detection areas.

### Solution to Problem

In order to meet the demand described above, one illustrative aspect of the presently disclosed subject matter provides an electrostatic sensor, comprising:

a detection device configured to detect an electrostatic capacitance between an operated member having a plurality of detection areas and an electrode having areas associated with the detection areas respectively; and

a control device configured to determine whether an operation is performed to each of the detection areas based on whether the electrostatic capacitance exceeds a first threshold value,

wherein in a case where the electrostatic capacitance exceeds the first threshold value for one of the detection areas, the control device determines whether an operation is performed to another detection area based on a second threshold value that is higher than the first threshold value.

In order to meet the demand described above, one illustrative aspect of the presently disclosed subject matter provides a control device configured to control an operation of an electrostatic sensor equipped with an operated member having a plurality of detection areas, comprising:

a reception interface configured to receive detection information corresponding to an electrostatic capacitance between the operated member and an electrode having areas associated with the detection areas respectively; and

a processor configured to determine whether an operation is performed to each of the detection areas based on whether the electrostatic capacitance exceeds a first threshold value,

wherein in a case where the electrostatic capacitance exceeds the first threshold value for one of the detection areas, the processor determines whether an operation is performed to another detection area based on a second threshold value that is higher than the first threshold value.

In order to meet the demand described above, one illustrative aspect of the presently disclosed subject matter provides a non-transitory computer-readable medium having stored a computer program adapted to be executed by a processor of a control device configured to control an operation of an electrostatic sensor equipped with an operated member having a plurality of detection areas, the computer program is configured to cause, when executed, the control device to:

receive detection information corresponding to an electrostatic capacitance between the operated member and an electrode having areas associated with the detection areas respectively;

determine whether an operation is performed to each of the detection areas based on whether the electrostatic capacitance exceeds a first threshold value; and

in a case where the electrostatic capacitance exceeds the first threshold value for one of the detection areas, determine whether an operation is performed to another detection area based on a second threshold value that is higher than the first threshold value.

According to the configuration as described above, when it is determined that an operation is performed to one of the detection areas provided in the operated member based on the fact that the detected electrostatic capacitance for the detection area exceeds the first threshold value, the determination as to whether an operation is performed to another detection area is made on the basis of the second threshold value that is higher than the first threshold value. Accordingly, it is possible to reduce the possibility that the determination is made such that an operation is performed to another detection area. As a result, when a user performs an operation to a certain detection area, even if a part of the occupant's body contacts or approaches another detection area unintentionally, it is possible to suppress an occurrence of a situation that the contact or approach is detected as an operation to another detection area. Accordingly, it is possible to improve the operability of the electrostatic sensor equipped with the operated member having a plurality of detection areas.

### BRIEF DESCRIPTION OF DRAWINGS

FIG. 1 illustrates a configuration of an electrostatic sensor according to an embodiment.

FIG. 2 illustrates a vehicle in which the electrostatic sensor of FIG. 1 is to be installed.

FIG. 3 illustrates a flow of processing executed by a control device of FIG. 1.

FIG. 4 illustrates an exemplary operation of the electrostatic sensor of FIG. 1.

FIG. 5 illustrates another exemplary operation of the electrostatic sensor of FIG. 1.

### DESCRIPTION OF EMBODIMENTS

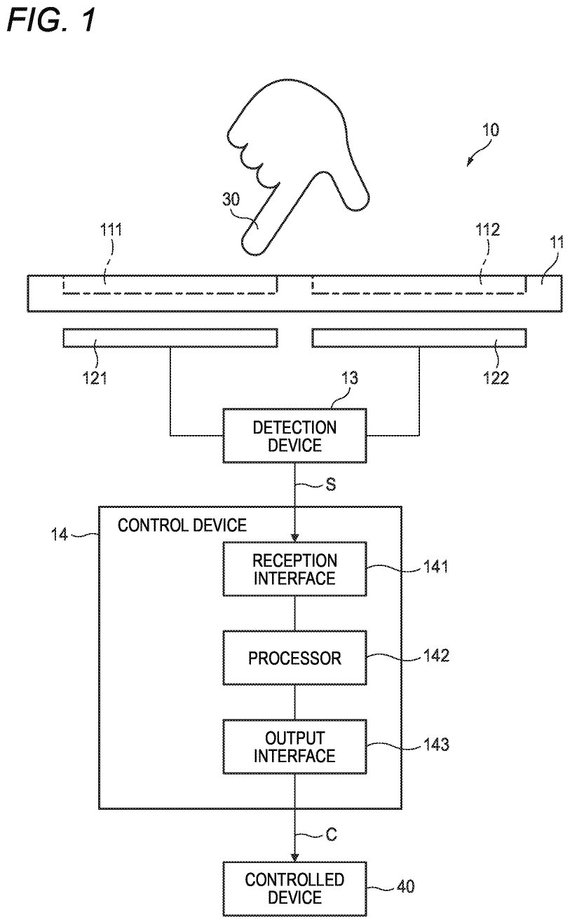

Examples of embodiments will be described in detail below with reference to the accompanying drawings. FIG. 1 illustrates a functional configuration of an electrostatic sensor 10 according to an embodiment.

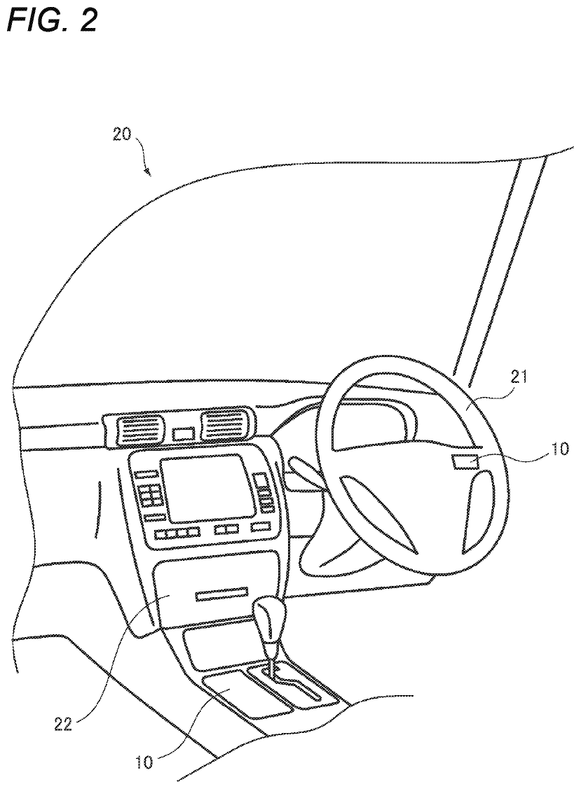

As illustrated in FIG. 2, the electrostatic sensor 10 is configured to be installed in a vehicle 20. For example, the electrostatic sensor 10 may be disposed on a steering wheel 21 or a center cluster 22 in a cabin of the vehicle 20. The electrostatic sensor 10 is configured to accept an operation performed by an occupant of the vehicle 20, and to remotely operate a controlled device installed in the vehicle 20 based on the operation. Examples of the controlled device include an air conditioner, a lighting device, an audio-visual equipment, a power window device, a seat device, etc. The vehicle 20 is an example of a mobile entity.

As illustrated in FIG. 1, the electrostatic sensor 10 includes an operated member 11. The operated member 11 is configured to accept an operation performed with a finger 30 of an occupant of the vehicle 20.

The operated member 11 has a first detection area 111 and a second detection area 112 on its surface. Each of the first detection area 111 and the second detection area 112 is an area capable of accepting an operation performed with the finger 30 for enabling a specific function of the controlled device 40. These areas are not structurally partitioned by the formation of grooves or steps on the surface, but at least one of a differently-colored portion, a mark, and an unevenness each of which has a small influence on the operation is appropriately provided on the surface, thereby causing the occupant to recognize the position of each area. In this example, the first detection area 111 and the second detection area 112 are adjacent to each other.

The electrostatic sensor 10 includes a first electrode 121 and a second electrode 122. The first electrode 121 has an area associated with the first detection area 111 of the operated member 11. The second electrode 122 has an area associated with the second detection area 112 of the operated member 11.

The electrostatic sensor 10 includes a detection device 13. The detection device 13 is configured to detect an electrostatic capacitance between the operated member 11 and the first electrode 121. The detection device 13 is configured to detect an electrostatic capacitance between the operated member 11 and the second electrode 122.

Specifically, the detection device 13 includes a charging/discharging circuit. The charging/discharging circuit can perform a charging operation and a discharging operation. The charging/discharging circuit during the charging operation supplies current supplied from a power source (not illustrated) to the first electrode 121 and the second electrode 122. The charging/discharging circuit during the discharging operation causes each electrode to emit current. An electric field is generated around the operated member 11 by the current supplied to each electrode. As the finger 30 approaches this electric field, a pseudo capacitor is formed between a particular electrode and the finger 30. As a result, the electrostatic capacitance between the specific electrode and the operated member 11 is increased. As the electrostatic capacitance increases, the current emitted from the particular electrode during the discharging operation increases.

That is, the detection device 13 can detect a position in the operated member 11 where the finger 30 approaches or contacts by detecting the electrostatic capacitance between the operated member 11 and each electrode. The detection device 13 is configured to output detection information S indicating a position in the operated member 11 where the finger 30 approaches or contacts. The detection information S may be in the form of analog data or may be in the form of digital data.

The electrostatic sensor 10 includes a control device 14. The control device 14 includes a reception interface 141, a processor 142, and an output interface 143.

The reception interface 141 is configured as an interface for receiving the detection information S outputted from the detection device 13. In a case where the detection information S is in the form of analog data, the reception interface 141 is configured to be equipped with an appropriate conversion circuit including an A/D converter.

As described above, the detection information S may indicate the position in the operated member 11 where the finger 30 approaches or contacts. The processor 142 is configured to determine that the finger 30 contacts or approaches the first detection area 111 or the second detection area 112 in the operated member 11 based on the detection information S.

The output interface 143 is configured as an interface for outputting control information C for controlling the operation of the controlled device 40. The processor 142 is configured to output the control information C from the output interface 143 based on the position in the operated member 11 at which the contact or approach of the finger 30 is detected. The control information C may be in the form of analog data or may be in the form of digital data. In a case where the control information C is in the form of analog data, the output interface 143 is configured to be equipped with an appropriate conversion circuit including a D/A converter.

For example, when it is detected that the finger 30 contacts or approaches the first detection area 111 based on the detection information S, the processor 142 outputs control information C for enabling one function of the controlled device 40 from the output interface 143. When it is detected that the finger 30 contacts or approaches the second detection area 112 based on the detection information S, the processor 142 outputs control information C for enabling another function of the controlled device 40 or one function of another controlled device 40 from the output interface 143.

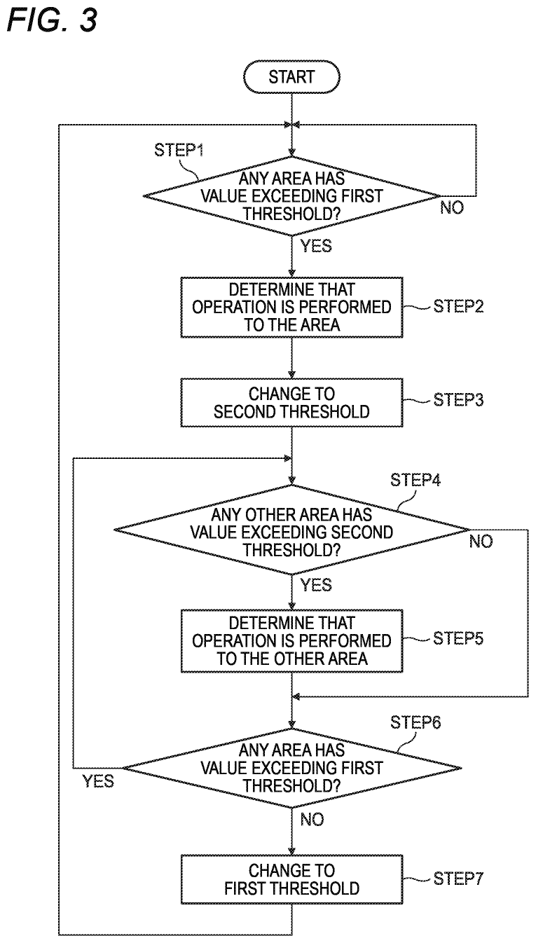

Referring to FIG. 3, a more specific flow of processing executed by the processor 142 of the control device 14 will be described.

The processor 142 determines whether there is any detection area associated with an electrode whose electrostatic capacitance with respect to the operated member 11 detected by the detection device 13 exceeds a first threshold value Th1 (STEP1). The determination is repeated until such a detection area is found (NO in STEP1).

When it is determined that there is any detection area associated with an electrode whose electrostatic capacitance with respect to the operated member 11 exceeds the first threshold value Th1 (YES in STEP1), the processor 142 determines that an operation with the finger 30 is performed to the detection area (STEP2). As described above, the processor 142 outputs the control information C associated with the operation from the output interface 143 to the controlled device 40.

The processor 142 then changes the first threshold value Th1 to a second threshold value Th2 (STEP3). The first threshold value Th1 is higher than the second threshold value Th2. The relationship between the first threshold value Th1 and the second threshold value Th2 can be appropriately determined. For example, a value obtained by adding or multiplying the first threshold value Th1 by a predetermined value may be set as the second threshold value Th2. The processing of STEP3 may be performed in parallel with the processing of STEP2, or may be performed prior to the processing of STEP2.

Next, in STEP4, the processor 142 determines whether there is another detection areas associated with the electrode whose electrostatic capacitance with respect to the operated member 11 detected by the detection device 13 exceeds the second threshold value Th2.

When it is determined that there is another detection area associated with the electrode whose electrostatic capacitance with respect to the operated member 11 exceeds the second threshold value Th2 (YES in STEP4), the processor 142 determines that the operation with the finger 30 is performed to another detection area (STEP5). As described above, the processor 142 outputs the control information C associated with the operation from the output interface 143 to the controlled device 40.

Next, in STEP6, the processor 142 determines whether there is any detection area associated with an electrode whose electrostatic capacitance with respect to the operated member 11 detected by the detection device 13 exceeds the first threshold value Th1.

When it is determined that there is any detection area associated with an electrode whose electrostatic capacitance with respect to the operated member 11 exceeds the first threshold value Th1 (YES in STEP6), the processor 142 determines that some operation with the finger 30 with respect to the operated member 11 is ongoing. The processor 142 then returns the processing to STEP4.

When it is determined that there is no detection area associated with the electrode whose electrostatic capacitance with respect to the operated member 11 exceeds the first threshold value Th1 (NO in STEP6), the processor 142 determines that the operation with the finger 30 to the operated member 11 is finished. The processor 142 then changes the threshold value as for the electrostatic capacitance to the first threshold value Th1 (STEP7), and returns the processing to STEP1.

When it is determined that there is no another detection area associated with the electrode whose electrostatic capacitance with respect to the operated member 11 exceeds the second threshold value Th2 (NO in STEP4), the processor 142 advances the processing to STEP6.

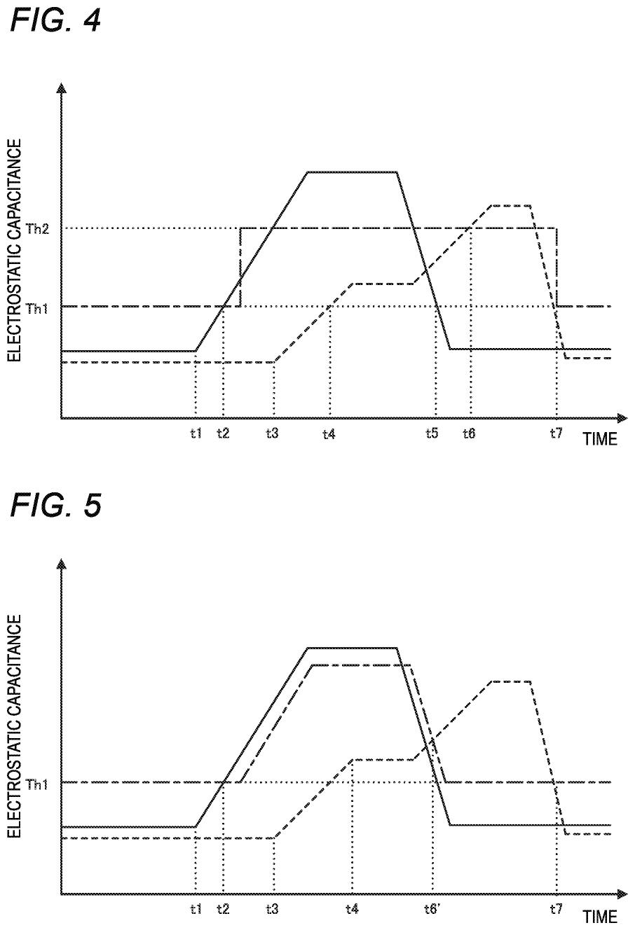

FIG. 4 illustrates an exemplary operation of the electrostatic sensor 10 configured as described above. The solid line represents the electrostatic capacitance between the operated member 11 and the first electrode 121 detected by the detection device 13. In the following descriptions, it will be simply referred to as “an electrostatic capacitance in the first detection area 111”. The dashed line represents the electrostatic capacitance between the operated member 11 and the second electrode 122 detected by the detection device 13. In the following descriptions, it will be simply referred to as “an electrostatic capacitance in the second detection area 112”. The chain line represents a threshold value of the electrostatic capacitance set by the control device 14. In the initial state, the electrostatic capacitance is set to the first threshold value Th1.

In the initial state, both the electrostatic capacitance in the first detection area 111 and the electrostatic capacitance in the second detection area 112 are less than the first threshold value Th1 (NO in STEP1 in FIG. 3). The electrostatic capacitance in the first detection area 111 starts to rise at a time point t1 and exceeds the first threshold value Th1 at a time point t2 (YES in STEP1 in FIG. 3). Accordingly, the processor 142 determines that an operation with the finger 30 is performed to the first detection area 111 (STEP2 in FIG. 3), and changes the threshold value of the electrostatic capacitance to the second threshold value Th2 higher than the first threshold value Th1 (STEP3 in FIG. 3).

Thereafter, the electrostatic capacitance in the second detection area 112 starts to rise at a time point t3, and exceeds the first threshold value Th1 at a time point t4. Such a phenomenon may be caused when the finger 30 operating the first detection area 111 unintentionally contacts or approaches the adjacent second detection area 112. However, since the electrostatic capacitance in the second detection area 112 is less than the second threshold value Th2 after the change, the processor 142 does not determine that the operation with the finger 30 is performed to the second detection area 112 (NO in STEP4 in FIG. 3).

On the other hand, since the electrostatic capacitance in the first detection area 111 at the time point t4 exceeds the second threshold value Th2 higher than the first threshold value Th1 (YES in STEP6), the processor 142 returns the processing to STEP4.

Thereafter, the electrostatic capacitance in the first detection area 111 starts decreasing, and falls behind the first threshold value Th1 at a time point t5. The processor 142 determines that the operation to the first detection area 111 is finished. On the other hand, since the electrostatic capacitance in the second detection area 112 exceeds the first threshold value Th1 (YES in STEP6 in FIG. 3), the processor 142 returns the processing to STEP4. It should be noted that even if the electrostatic capacitance in the first detection area 111 is less than the first threshold value Th1, in a case where the electrostatic capacitance in the second detection area exceeds the first threshold value Th1 (YES in STEP6), the processor 142 may be configured to determine that the operation to the first detection area 111 is not finished.

Thereafter, at a time point t6, the electrostatic capacitance in the second detection area 112 exceeds the second threshold value Th2 (YES in STEP4 in FIG. 3). Accordingly, the processor 142 determines that an intended operation is performed to the second detection area 112 (STEPS in FIG. 3).

Thereafter, the electrostatic capacitance in the second detection area 112 starts decreasing, and falls behind the first threshold value Th1 at a time point t7 (NO in STEP6 in FIG. 3). When it is determined that the operation with respect to the operated member 11 is finished, the processor 142 changes the threshold value of the electrostatic capacitance to the first threshold value Th1 (STEP7 in FIG. 3).

According to the configuration as described above, when it is determined that an operation is performed to one of the detection areas provided in the operated member 11 based on the fact that the detected electrostatic capacitance for the detection area exceeds the first threshold value Th1, the determination as to whether an operation is performed to another detection area is made on the basis of the second threshold value Th2 that is higher than the first threshold value Th1 Accordingly, it is possible to reduce the possibility that the determination is made such that an operation is performed to another detection area. As a result, when an occupant performs an operation to a certain detection area, even if a part of the occupant's body contacts or approaches another detection area unintentionally, it is possible to suppress an occurrence of a situation that the contact or approach is detected as an operation to another detection area. Accordingly, it is possible to improve the operability of the electrostatic sensor equipped with the operated member having a plurality of detection areas.

On the other hand, the acceptance of an operation to another detection area per se is not prohibited, but such an operation is detected when the electrostatic capacitance detected for another detection area exceeds the second threshold value Th2. In other words, unintentional contact or approach and intentional contact or approach can be clearly distinguished. Accordingly, the second threshold value Th2 higher than the first threshold value Th1 is preferably set as such a value that is not exceeded by the unintentional contact or approach but is exceeded by the intentional contact or approach.

FIG. 5 illustrates another exemplary operation of the electrostatic sensor 10. In this example, the processor 142 of the control device 14 is configured to change the threshold value as for the electrostatic capacitance in accordance with the electrostatic capacitance in a detection area that initially exceeds the first threshold value Th1 . Specifically, a value obtained by multiplying the electrostatic capacitance by a value less than 1 (e.g., 0.9) is set as the second threshold value Th2. As in the prior example, the value less than 1 may be set as a value such that the obtained second threshold value Th2 is not exceeded by the unintentional contact or approach but is exceeded by the intentional contact or approach.

The chronological change of the electrostatic capacitance in the first detection area 111 and the chronological change of the electrostatic capacitance in the second detection area 112 illustrated in FIG. 5 are the same as those illustrated in FIG. 4. However, the electrostatic capacitance in the second detection area 112 exceeds the second threshold value Th2 at a time point t6′ earlier than the time point t6 in FIG. 4, thereby it is determined that an operation to the second detection area 112 is performed. According to such a configuration, since the second threshold value Th2 changes in accordance with the electrostatic capacitance of a detection area that initially accept an operation, the finish of the operation to the detection area is reflected to the second threshold value Th2 more quickly. As a result, it is possible to advance a timing for enabling the determination that a next operation is performed to another detection area.

The processor 142 having each function described above can be implemented by a general-purpose microprocessor operating in cooperation with a general-purpose memory. Examples of the general-purpose microprocessor include a CPU, an MPU, and a GPU. Examples of the general-purpose memory include a ROM and a RAM. In this case, a computer program for executing the above-described processing can be stored in the ROM. The ROM is an example of a non-transitory computer-readable medium having stored a computer program. The general-purpose microprocessor designates at least a part of the program stored in the ROM, loads the program on the RAM, and executes the processing described above in cooperation with the RAM. The above-described computer program may be pre-installed in a general-purpose memory, or may be downloaded from an external server via a communication network and then installed in the general-purpose memory. In this case, the external server is an example of the non-transitory computer-readable medium having stored a computer program.

The processor 142 may be implemented by a dedicated integrated circuit capable of executing the above-described computer program, such as a microcontroller, an ASIC, and an FPGA. In this case, the above-described computer program is pre-installed in a memory element included in the dedicated integrated circuit. The memory element is an example of the non-transitory computer-readable medium having stored a computer program. The processor 142 may also be implemented by a combination of a general-purpose microprocessor and a dedicated integrated circuit.

The above embodiments are merely illustrative for facilitating understanding of the presently disclosed subject matter. The configuration according to the above embodiment can be appropriately modified or improved without departing from the gist of the presently disclosed subject matter.

In the above embodiment, the operated member 11 has two detection areas. However, the number of the detection areas may be three or more. The position, shape, size, and type of operation that can be accepted of each detection area in the operated member 11 can be appropriately determined according to the function of the controlled device 40 to be controlled.

In the above embodiment, the absolute value of the detected electrostatic capacitance is used for comparison with the first threshold value Th1 in order to determine whether an operation is performed to the detection area of the operated member 11. However, the determination as to whether the operation with respect to the detection area is performed may be made based on an amount of change from a reference electrostatic capacitance that can be constantly changed according to the state of the operated member 11. In this case, a first threshold value Th1 defined for the amount of change is used.

In the above embodiment, the electrostatic capacitance between the operated member 11 and the finger 30 of the occupant is detected. As long as a change in the electrostatic capacitance caused by an operation performed to the operated member 11 can be detected, the operation may be performed with another body part, or with clothing or a tool interposed between the body part and the operated member 11.

The electrostatic sensor 10 may be installed in a mobile entity other than the vehicle 20. Examples of the mobile entity include railways, aircraft, and ships. The mobile entity may not require a driver. The electrostatic sensor 10 may be installed in a mobile device capable of being carried by a user. A mobile device may also be an example of the mobile entity. When the electrostatic sensor 10 is provided in such a mobile entity, a part of the user's body tends to contact or approach an undesired detection area due to the movement or vibration of the mobile entity. Accordingly, the utility of the electrostatic sensor 10 having the configuration as described above is further enhanced.

The electrostatic sensor 10 need not be installed in a mobile entity. As long as the operation of the controlled device 40 can be controlled through an operation performed to the operated member 11, the illustrated configuration can be applied to any application, such as a stationary device, a building such as a house or a facility.

The present application is based on Japanese Patent Application No. 2020-098572 filed on Jun. 5, 2020, the entire contents of which are incorporated herein by reference.

What is claimed is:

1. An electrostatic sensor, comprising:
a detection device configured to detect an electrostatic capacitance between an operated member having a plurality of detection areas and an electrode having areas associated with the detection areas respectively; and
a control device configured to determine whether an operation is performed to each of the detection areas based on whether the electrostatic capacitance exceeds a first threshold value,
wherein in a case where the electrostatic capacitance exceeds the first threshold value for one of the detection areas, the control device determines whether an operation is performed to another detection area based on a second threshold value that is higher than the first threshold value.

2. The electrostatic sensor according to claim 1, wherein the control device is configured to change the second threshold value in accordance with change in the electrostatic capacitance that has exceeded the first threshold value.

3. The electrostatic sensor according to claim 1, being configured to be installed in a mobile entity.

4. A control device configured to control an operation of an electrostatic sensor equipped with an operated member having a plurality of detection areas, comprising:
a reception interface configured to receive detection information corresponding to an electrostatic capacitance between the operated member and an electrode having areas associated with the detection areas respectively; and
wherein in a case where the electrostatic capacitance exceeds the first threshold value for one of the detection areas, the processor determines whether an operation is performed to another detection area based on a second threshold value that is higher than the first threshold value.

5. A non-transitory computer-readable medium having stored a computer program adapted to be executed by a processor of a control device configured to control an operation of an electrostatic sensor equipped with an operated member having a plurality of detection areas, the computer program is configured to cause, when executed, the control device to:
receive detection information corresponding to an electrostatic capacitance between the operated member and an electrode having areas associated with the detection areas respectively;
determine whether an operation is performed to each of the detection areas based on whether the electrostatic capacitance exceeds a first threshold value; and
in a case where the electrostatic capacitance exceeds the first threshold value for one of the detection areas, determine whether an operation is performed to another detection area based on a second threshold value that is higher than the first threshold value.
